(19) United States
(12) Patent Application Publication
(10) Pub. No.: US 2009/0216627 A1
(43) Pub. Date: Aug. 27, 2009

(54) METHOD, SYSTEM AND SOFTWARE FOR TALENT MANAGEMENT

(75) Inventors: Michael James Carden, Auckland (NZ); Mark Evan Hellier, Auckland (NZ)

Correspondence Address: FOLEY AND LARDNER LLP;SUITE 500, 3000 K STREET NW, WASHINGTON, DC, 20007, US

(73) Assignee: Sonar Limited

(21) Appl. No.: 12/097,497

(22) PCT Filed: Dec. 12, 2006
(86) PCT No.: PCT/NZ2006/000326

§ 371 Date: Oct. 24, 2008

(30) Foreign Application Priority Data
Dec. 16, 2005 (NZ) 544229

(51) Int. Cl. G06Q 10/00

(52) U.S. Cl. 705/11

(57) ABSTRACT

A method of analysing talent within an organisation including the step of displaying a graph showing the frequency of values of a factor for a plurality of individuals within the organisation.

### FIELD OF INVENTION

The present invention relates to a method, system and software for analyzing talent within an organisation. More particularly, but not exclusively, the present invention relates to a method, system and software for analyzing talent within an organisation by providing a frequency graph of individuals with a specified human resource attribute.

### BACKGROUND TO THE INVENTION

Talent Management is the practice and process of ensuring an organisation has the capability and capacity to deliver both the operational and strategic goals of that organisation using the most appropriate resources.

Talent are all individuals within an organisation irrespective of their current position or ranking. Managing talent applies to work and understanding around those with poor performance and limited potential just as it does the star performers and high potential employees.

Talent in an organisation is measured as a combination of performance and potential; performance is a measure of how well an individual is doing today and potential is a measure of how well the individual is likely to do in the long term. To further define performance and potential each can be broken down into a set of factors, which are attributes or behaviours that the organisation believes are important for staff to have strength in.

In relation to Talent Management within a company, a key element of understanding how to develop and advance the capability of the company involves understanding what factors the company's employees are strong in, and what factors their employees are weak in. For instance, if the company has many employees who are weak in customer service, then the company is likely to want to address customer service as a training concern. Conversely, if a company has many employees who are strong in innovation, it will want to capitalise on this strength.

Additionally, specific projects in an organisation, or specific roles, often require selecting an employee with specific strengths. For instance, to find the right employee to lead the sales team would normally mean finding an employee with strength in sales as well as strength in leadership.

At present these sort of issues are handled by informal methods, or a “gut feeling” on the part of managers. Occasionally a more formal method, such as an employee survey is used, however these methods tend to focus on just a sample of employees, and tend to look at elements like employee satisfaction rather than specific factor strengths and weaknesses.

A further disadvantage with all of these methods is that management never has a clear picture of the factor situation in the company. Without organising this information in a way that is easy to understand and interpret, decisions will always be made that are only partially informed and hard to post-justify.

It is an object of the present invention to overcome the limitations of the above methods by providing a method for analyzing talent management using frequency graphs in way that is easy to understand and interpret, or to at least provide the public with a useful choice.

### SUMMARY OF THE INVENTION

According to a first aspect of the invention there is provided a method of analysing talent within an organisation including the step of:
displaying a graph showing the frequency of values of a human resources factor for a plurality of individuals within the organisation.

It is preferred that factor is an attribute or a behaviour. It is further preferred that the factor is related to a performance metric or a potential metric.

The method may include the step of a user actuating a segment of the graph to display further detail. This segment may be one of a plurality of segments, each forming an equal portion of the graph and the size of the segment may be dependent on the number of individuals within the graph or organisation. The further detail displayed may include the list of individuals within that segment.

The method may also include the steps of: selecting an individual; and displaying an icon representing the individual on the graph corresponding to the value of the factor for the selected individual.

The method may include the step of displaying a plurality of historical icons representing the individual on the graph, each historical icon corresponding to a historical value of the factor for the selected individual. It is preferred that at least some of the historical icons are visually faded dependent on the age of the historical values.

The method may include the steps of displaying a plurality of graphs, each graph showing the frequency of values of a factor for a plurality of individuals within the organisation; wherein each graph corresponds to a unique factor.

Preferably, the method includes the step of a user defining the plurality of individuals by selecting a group within the organisation. It is preferred that group is defined by either pay band, region, or function.

Preferably, the frequency graph is an area histogram.

According to another aspect of the invention there is provided a method of analysing an individual for managing talent including the steps of:
displaying a first graphical representation of a first set of data of an individual in a first shade of a colour; and
displaying a second graphical representation of a second set of data for the individual in a second shade of the colour;
wherein the first set of data relates to the individual at an later time than the second set of data, and the second shade is lighter than the first shade.

Preferably the first and second graphical representations are icons described for the first aspect of the invention.

According to another aspect of the invention there is provided a system for analysing talent within an organisation including:
a database arranged for storing a factor value for each of a plurality of individuals within the organisation;
a processor arranged for calculating frequencies of the factor values; and
a display device arranged for displaying a graph showing the frequencies.

According to another aspect of the invention there is provided software for analysing talent within an organisation including:
a data structure arranged for storing a factor value for each of a plurality of individuals within the organisation;
a module arranged for calculating frequencies of the factor values; and
a module arranged for displaying a graph of the frequencies.

### BRIEF DESCRIPTION OF THE DRAWINGS

Embodiments of the invention will now be described, by way of example only, with reference to the accompanying drawings in which:

FIG. 1: shows a flow diagram illustrating a method of the invention.

FIG. 2: shows a screenshot illustrating multiple frequency charts of employees to factors according to a method of the invention.

FIG. 3: shows a screenshot illustrating the selection of a segment of a chart and display of a list of corresponding employees according to a method of the invention.

FIG. 4: shows a screenshot illustrating display of icons for an employee across multiple charts according to a method of the invention.

FIG. 5: shows a diagram illustrating how the invention may be deployed on hardware.

### DETAILED DESCRIPTION OF PREFERRED EMBODIMENTS

The present invention relates to a method, software and system for analyzing talent within an organisation by providing a frequency graph of individuals to human resource attribute.

The present invention will be described in relation to a company, and the factors of employees within that company.

However, it will be appreciated by those skilled in the art that the method may be applied to other organisations.

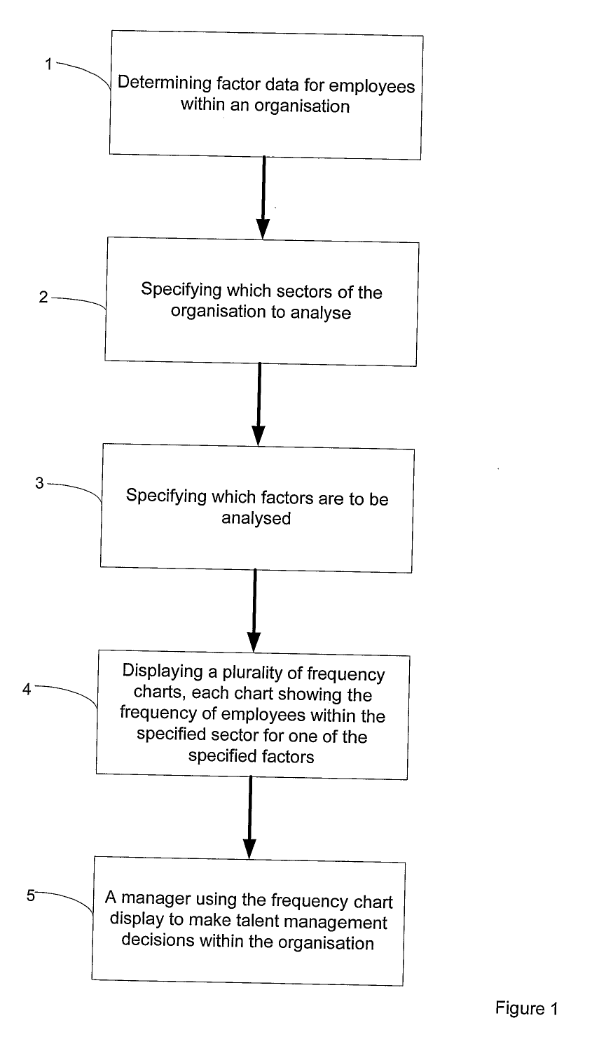

Referring to FIG. 1, a method of the invention will be described.

In step 1, factor data for the employees of an organisation is determined. The factors data can be determined by a manager using a questionnaire, a rating scale, or can be provided as output from an employee assessment tool, such as an interactive software tool for rating an employee. The data can be stored in a database.

In step 2, the sector of the organisation to analyse is specified. The type of sector to be selected can be business function, pay band, or geographical region. It will be appreciated that other ways of specifying a group of individuals within the organisation may be used. The sector can be specified by the user within a GUI, such as selecting from a pull-down menu.

In step 3, the factors or type of factors to be analysed is specified. The factors include performance factors such as “Team revenue performance”, “Client satisfaction” or “Quality of work”, and potential factors such as “Inspiring people leadership”, “Delegation effectiveness”. The type of factors can be performance or potential factors. The factors can be selected by a user within GUI, such as selecting a tab marked “Performance Factors”.

In step 4, the frequency of employees within that sector is graphed in relation to their level within the selected factors. If a number of factors are specified in step 2, a frequency graph for each factor is displayed. The frequency graphs can be displayed within a GUI. If there a plurality of graphs, they can be displayed within the same window of the GUI.

In step 5, a manager of the organisation makes a decision based on viewing the displayed frequency charts in step 4.

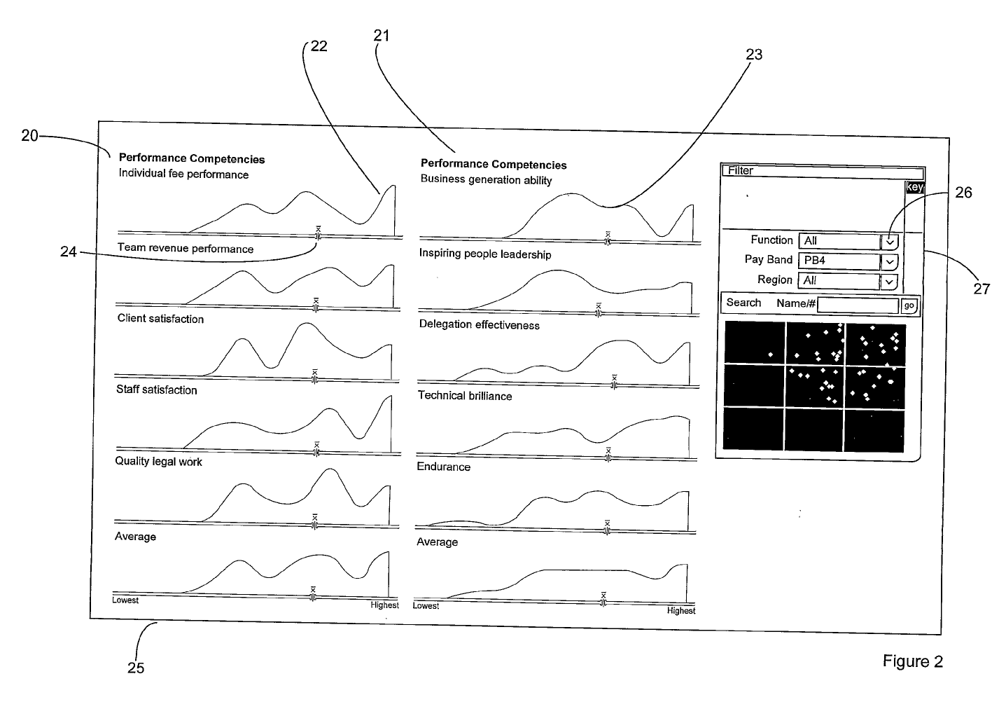

FIG. 2 shows a screenshot which depicts the initial view of an entire organisation's distribution of employee ratings from best to worst against a set of performance competencies 20 (performance factors) and a set of potential competencies 21 (potential factors), graphed on frequency charts 22 and 23.

The average 24 within each frequency chart is also marked.

Factors are attributes or behaviours that the company believes are important for staff to have strength in, and to have been measured in. For instance one performance factor is “Individual Fee Performance”.

There are a multitude of factors that can be measured. Each factor requires a definition and description of how that behaviour manifests itself and the scale by which an individual could be evaluated/ranked against that factor.

It will be appreciated that factors other than performance and potential factors can be measured and graphed in this way such as personality traits, work style and preference, and leadership.

Showing a distribution of people against a factor immediately conveys to a manager the organisation's relative strength or weakness for that factor, as well additional information related to the spread of the population's scores. For instance employees for a factor such as customer satisfaction might fall into two distinct groups—one group with strong scores and another with weak scores. This is much more useful than being able to see only an average as it provides the user additional context before they respond. In this example they might be able to use the “strong” group to develop the “weak” group. Alternatively they might find that different business units had very different approaches to customer satisfaction, resulting in very different scores.

In this example, multiple charts are shown at once within one screen 25. This provides the user with a snapshot of the organisation's strengths and weaknesses across a number of measured factors.

The advantage of this is that it allows the user to understand the whole picture of the organisation's strengths and weaknesses at a glance, as well as compare between factors.

In this example, these frequency charts used are histograms, with the area under the chart between any two points along the horizontal axis representing the number of employees who have scored between those two points. It will be appreciated that other graph types can be used to display this data, such as bar charts.

The information can be filtered to display specific business units, regions or other segmentations, in any kind of combination, by a user selecting options from a pull-down menu 26 within the tool bar 27. This ability to “drill down” gives the user the ability to interrogate the data in multiple ways, and make complex analyses easily.

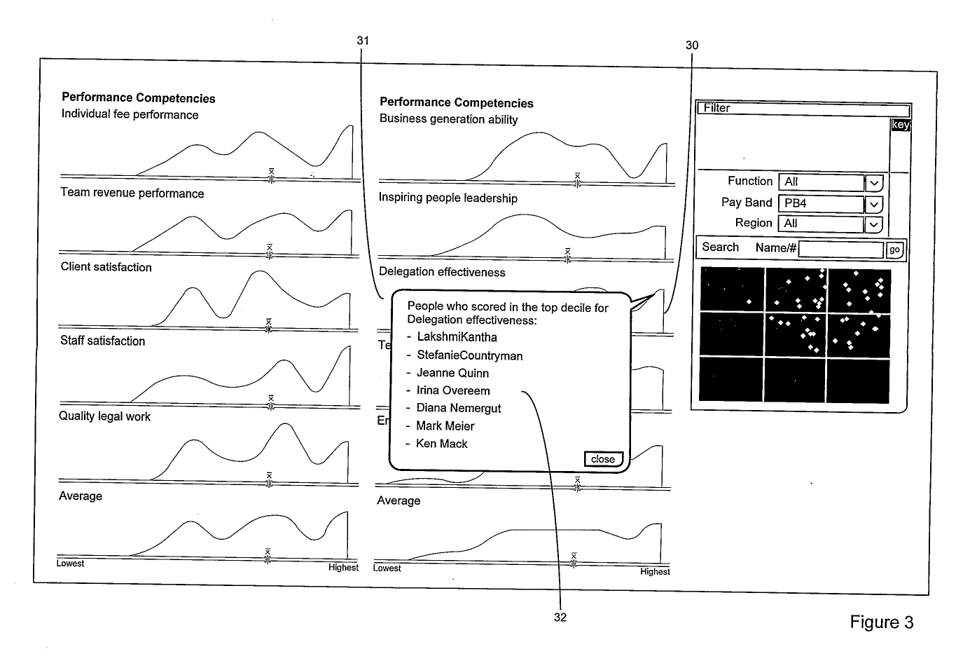

Referring to FIG. 3, when a user clicks on a segment 30 of the chart 31 a list 32 of employees who scored in that segment for that factor will be displayed. The segments for a graph are of equal widths and this width is related to the size of the population being graphed. For instance for a population of a hundred the graphs would be segmented into ten; meaning that the segment width is one tenth of the total graph width. It will be appreciated that a user can select segments in different ways such as by clicking and dragging to select multiple segments. Furthermore, it will be appreciated that the segments sizes may not be equal.

The advantage of this aspect of the invention is that it is very easy to identify top performers for a specific factor. For instance, if an employee with very good “Client Satisfaction” is required for a specific role in the company it is very easy to find the top performers amongst employees in that factor. Conversely identifying employees with a specific weakness in “Client Satisfaction” as a group (e.g. the bottom three segments of the graph) to send on a customer service remedial training course is very easy.

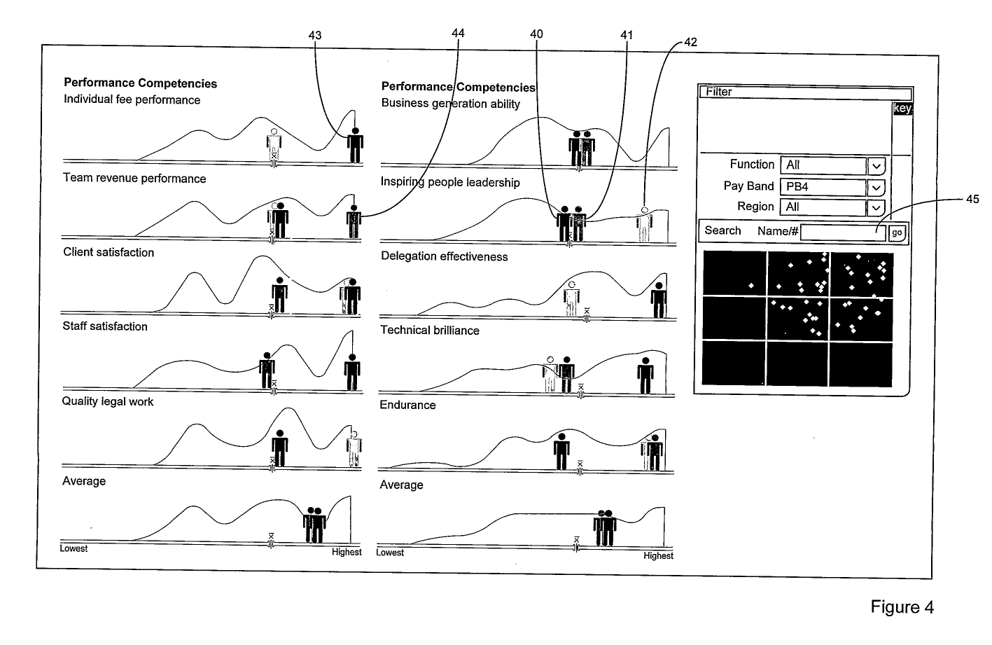

Referring to FIG. 4, if an employee is selected from this list (for example, by a user clicking the name with a pointer) then the employee's scores 40, 41, 42, 43, and 44 for all of the factors measured will appear against the charts. The most current assessment scores will be displayed with a solid icon 40, historical scores are displayed with faded icons 41 and 42, the older the assessment the more faded the icon.

The advantage of this is that it provides a quick way of checking how a selected employee has scored against other relevant factors.

The faded historical icons 41 and 42 show the history of the employee's scores against the factor. This permits the user to assess the consistency of the employee's scores, as well as to identify trends in the score of the employee. It provides a visual answer to the question “Is the person getting better, are they getting worse, are they static, or are they inconsistent?” Depending on the answer to that question, there will be often a different management response required.

An employee can also be selected and displayed on this chart by searching for their name or ID in the database using the search field 45.

The advantage of this is that an employee's strengths and weaknesses can easily be shown in comparison to a population of their peers. For instance, if an employee (i.e. a northern region salesperson) is poor at “Client Satisfaction” and the rest of the northern region sales team is very strong at “Client Satisfaction”, then there is a problem that needs to be addressed with that employee. If on the other hand the employee is poor at “Client Satisfaction” and the whole of the northern region sales team is also poor at this factor, then there is a different problem (possibly with the northern region sales manager) that needs to be addressed.

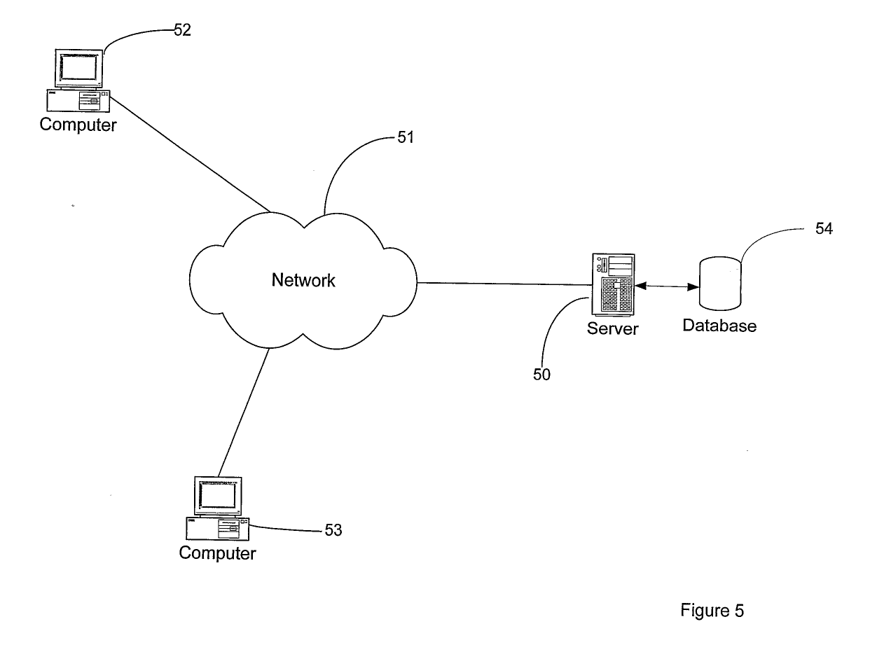

Referring to FIG. 5, a deployment of the system will be shown.

A server 50 records data relating to all employees within the organisation.

A computer 52 can connect to the server 50 via a LAN or the Internet 51. The user on computer 52 sets factor levels for the employees within a GUI. Computer 52 transmits the factor levels to the server.

The server 50 collates the factors within a database 54.

A user on computer 53 requests information relating to a sector of the organisation for one or more factors using a GUI.

The server 50 transmits data relating to the information request from the database to computer 53.

Computer 53 displays the data within one or more frequency graphs within a GUI, each graph showing the frequency of employees for factor value.

The GUI on the computer 53 accepting user input to display or further analyse detail about the frequency graphs.

The user on computer 53 viewing the displayed graphs to make a management decision based on the charts.

It will be appreciated that other deployments scenarios, such as within one computing device, are envisioned.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1.-28. (canceled)

29. A computer implemented method of analyzing talent within an organization including the step of:
displaying a graph showing a frequency measurement of individuals associated with values of a single factor for a plurality of individuals within the organization.

30. A method as claimed in claim 29 wherein the factor is an attribute.

31. A method as claimed in claim 29 wherein the factor is a behavior.

32. A method as claimed in claim 29 wherein the factor is related to a performance metric.

33. A method as claimed in claim 29 wherein the factor is related to a potential metric.

34. A method as claimed in claim 29 including the step of a user actuating a segment of the graph to display further detail.

35. A method as claimed in claim 34 wherein the segment is one of a plurality of segments, each forming an equal portion of the graph.

36. A method as claimed in claim 34 wherein the size of the segment is dependent on the number of individuals within the graph or organization.

37. A method as claimed in claim 34 wherein the segments are deciles of the graph.

38. A method as claimed in claim 34 wherein the segments are quartiles of the graph.

39. A method as claimed in claim 34 wherein the further detail includes the list of individuals within that segment.

40. A method as claimed in claim 34 wherein the user actuation is user selection of the segment via a graphical user interface.

41. A method as claimed in claim 29 including the steps of:
selecting an individual; and
displaying an icon representing the individual on the graph corresponding to the value of the factor for the selected individual.

42. A method as claimed in claim 41 including the step of displaying a plurality of historical icons representing the individual on the graph, each historical icon corresponding to a historical value of the factor for the selected individual.

43. A method as claimed in claim 42 wherein at least some of the historical icons are visually faded dependent on the age of the historical values.

44. A method as claimed in claim 29 including the step of:
displaying a plurality of graphs, each graph showing the frequency of values of a factor for a plurality of individuals within the organization;
wherein each graph corresponds to a unique factor.

45. A method as claimed in claim 29 wherein the factor is a human resource factor.

46. A method as claimed in claim 29 including the step of a user defining the plurality of individuals by selecting a group within the organization.

47. A method as claimed in claim 46 wherein the group is defined by one of the set of pay band, region, and function.

48. A method as claimed in claim 29 wherein the graph is an area histogram.

49. A computer implemented method of analysing an individual for managing talent including the steps of:
displaying a first graphical representation of a first set of data of an individual in a first shade of a colour on a graph; and
displaying a second graphical representation of a second set of data for the individual in a second shade of the colour on the graph;
wherein the first set of data relates to an analysis of the individual at an later time than the second set of data, and the second shade is lighter than the first shade.

50. A method as claimed in claim 49 wherein the first and second graphical representations are icons.

51. A system for analyzing talent within an organization including:
a database arranged for storing a factor value for each of a plurality of individuals within the organization;
a processor arranged for calculating frequency measurements of individuals associated with values of a single factor; and
a display device arranged for displaying a graph showing the frequency measurements.

52. Software for analyzing talent within an organization including:
a data structure arranged for storing a factor value for each of a plurality of individuals within the organization;
a module arranged for calculating frequency measurements of individuals associated with values of a single factor; and
a module arranged for displaying a graph of the frequency measurements.

53. A system arranged for performing the method as claim 29.

54. Software arranged for performing the method as claim 29.

55. Storage media storing software as claimed in claim 52.

56. A computer implemented method or system of analyzing talent within an organization substantially as herein described with reference to FIGS. 1 to 4.
